(19) United States
(12) Patent Application Publication
(10) Pub. No.: US 2014/0198048 A1
(43) Pub. Date: Jul. 17, 2014

(54) REDUCING ERROR RATES FOR TOUCH BASED KEYBOARDS

(71) Applicant: NUANCE COMMUNICATIONS, INC., Burlington, MA (US)

(72) Inventors: Erland Unruh, Seattle, WA (US); David J. Kay, Seattle, WA (US)

(73) Assignee: NUANCE COMMUNICATIONS, INC., Burlington, MA (US)

(21) Appl. No.: 13/873,078

(22) Filed: Apr. 29, 2013

Related U.S. Application Data
(63) Continuation of application No. 13/830,674, filed on Mar. 14, 2013.
(60) Provisional application No. 61/752,431, filed on Jan. 14, 2013.

(51) Int. Cl. G06F 3/023; G06F 3/041

(52) U.S. Cl. CPC G06F 3/0237; G06F 3/0412
USPC 345/168

(57) ABSTRACT

The present technology provides systems and methods for reducing error rates to data input to a keyboard, such as a touch screen keyboard. In one example, an input bias model dynamically changes the keyboard functionality such that the keyboard will not necessarily produce the same result for an identical tap coordinate. Rather, the keyboard functionality is adapted to account for key offset bias that occurs when the user has a tendency to select a tap coordinate that would otherwise return an unintended key. Additionally, the present technology provides a language feedback model that may provide a probability for a next tap coordinate and may augment the key corresponding to the most probable next tap coordinate, thereby allowing the user to more easily select the correct key. Further details are provided herein.

### CROSS-REFERENCE TO RELATED APPLICATION(S)

This application is a continuation application of U.S. patent application Ser. No. 13/830,674, filed Mar. 14, 2013, which claims the benefit of U.S. Provisional Application No. 61/752,431, filed Jan. 14, 2013, each of which is hereby incorporated herein by reference in its entirety.

### BACKGROUND

The origin of the modern keyboard as the primary method for inputting text from a human to a machine dates back to early typewriters in the 19th century. As computers were developed, it was a natural evolution to adapt the typewriter keyboard for use as the primary method for inputting text. For a skilled typist, it has remained the fastest way possible to input text into a computer or other data processing device.

With ongoing efforts to make computers smaller and more portable, the physical keyboard has become one of the most significant limiting factors in just how small a device can become: the physical size of the human finger is not something computer designers could change. As a result, computers for certain portable applications have been designed without a physical keyboard, and use touch-screen or other input methods as the primary form of the human computer interface. This is also the case for some applications where people are physically unable to use a keyboard, such as persons with physical disabilities.

There are various requirements for physical and virtual keyboard input methods, such as methods for mobile devices or other computing devices, which frequently conflict with each other. The method of input should be as fast as possible and the correction of typing mistakes should be efficient and easy to perform, while the input interface should take as little of the display screen as possible. Unfortunately, as the available space is decreased, it may become difficult to increase speed without adversely affecting accuracy.

Therefore, the need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 illustrates an example of a computing environment in which some aspects of the present invention may be utilized.

FIG. 2 illustrates a set of components for a local input and language processing system.

FIG. 3 illustrates a set of components for a master processing system.

FIG. 4 is a block diagram illustrating components of a mobile device or other suitable computing device.

FIG. 5 is a block diagram illustrating components employed by an intended contact component system.

FIG. 6A is a flow diagram illustrating a routine for determining intended contact probabilities during a contact event based on the overlap with a candidate key and a circle centered at the center of a contacted key that completely covers the contacted key without completely covering any adjacent keys.

FIG. 6B is a schematic diagram illustrating identified candidate keys following an example implementation of the routine of FIG. 6A.

FIG. 7A illustrates an example of a continuous probability density based key entry scheme on a portion of a first keyboard.

FIG. 7B illustrates a discrete probability density based upon FIG. 7A.

FIG. 8 is a flow diagram illustrating a routine for updating a keyboard landscape in accordance with a bias input model described herein.

FIG. 9 is a flow diagram illustrating a routine for determining the predicted next key and enlarging the predicted next key on a keyboard.

FIG. 10 illustrates touch keyboards in accordance with embodiments of the present invention.

FIGS. 11-15 illustrate a touch keyboard having touch-areas that yield a set of expected neighbor keys.

FIG. 16 illustrates the input of sample words with relatively heavy bias.

FIG. 17 represents a neutral map that results after running an English language test with no language model feedback applied.

### DETAILED DESCRIPTION

The present technology provides systems and methods for an input bias model and a language model that dynamically change a virtual keyboard input area or landscape. The disclosed input bias model dynamically changes a virtual keyboard landscape such that the keyboard will not necessarily produce the same result for an identical tap coordinate. Rather, the keyboard landscape is adapted to account for key offset bias that occurs when the user has a tendency to select a tap coordinate that would otherwise return an unintended key (e.g. type closer to the V key, but the B key was intended). The disclosed language feedback model provides a conditional probability for the next tap coordinate and augments the effective size of the key corresponding to the most probable next tap coordinate, thereby allowing the user to more easily select the correct key. By combining the input bias model with the language model, a greatly improved user input keyboard results.

A system is described in detail below that employs a first action or step of collecting data input to a keyboard, processes the input, and then provides an output to the user. The system may reallocate virtual areas between keys (plus some) in a dynamic fashion, where an “exact” or protected virtual center area of a key can change in probability. For example, at first the very center of a key has the maximum probability for that key, but after usage (with bias as explained herein) that point could move away from the center, but still retain a center protected area with the now larger area. The system provides feedback to a user to reflect a current character that the system interprets from the user's input.

Without limiting the scope of this detailed description, examples of systems, apparatus, methods and their related results according to the embodiments of the present disclosure are given below. Unless otherwise defined, all technical and scientific terms used herein have the same meaning as commonly understood by one of ordinary skill in the art to which this disclosure pertains. In the case of conflict, the present document, including definitions will control. The terms used in this detailed description generally have their ordinary meanings in the art, within the context of the disclosure, and in the specific context where each term is used. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Overview

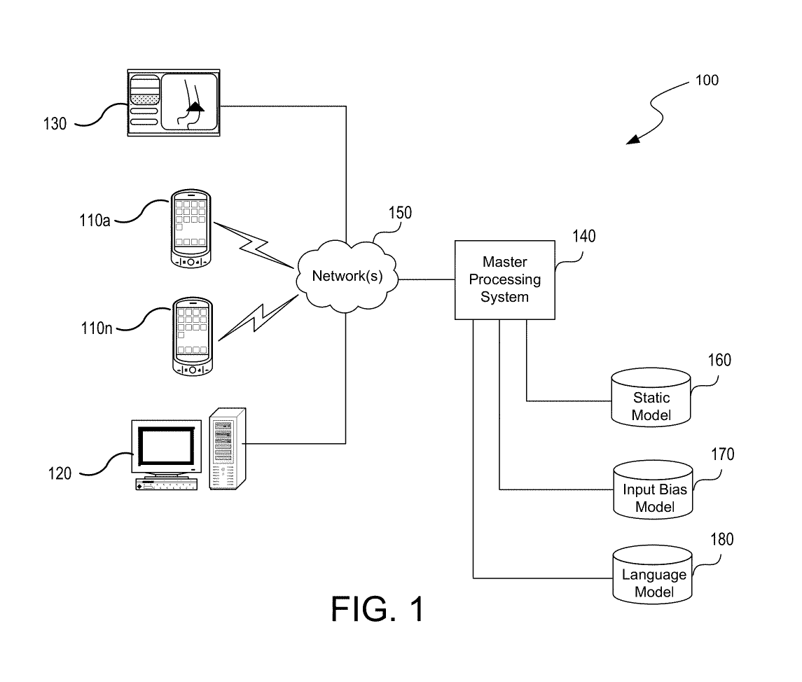

Starting with FIG. 1, the discussion herein provides a brief, general description of a suitable computing environment in which aspects of the present invention can be implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM or flash semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

Aspects of the invention will now be described, beginning with a suitable or representative environment in which the invention may be practice, including with a local and/or remote/central model, where the one or more models provide input bias and language feedback model. Thereafter, details of the input bias and language feedback model are provided.

### Representative Environment

FIG. 1 illustrates an example of a computing environment 100 in which embodiments of the present invention may be utilized. As illustrated in FIG. 1, an input bias and language feedback model (“input and language system”) may be operating on one or more mobile devices 110a-n (such as a mobile phone, tablet computer, mobile media device, mobile gaming device, electronic reader, media viewer, vehicle-based computer, etc.), one or more computing devices (such as computer 120), and other devices capable of receiving user inputs (e.g., such as navigation system 130). Each of these devices can include various input mechanisms (e.g., microphones, keypads, and/or touch screens) to receive user interactions (e.g., voice, text, and/or handwriting inputs).

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirement for some embodiments but not other embodiments.

As illustrated in FIG. 1, devices can communicate with master language and input processing system 140 through one or more wired or wireless, public or private, networks 150. In accordance with one embodiment, a static model 160, input bias model 170, and language model 180 of the local devices may communicate with a master language model that itself may include multiple models such as static model 160, input bias model 170, and dynamic language model 180, as well as other models such as any models to improve data input via a virtual keyboard on the local devices, all of which is described in greater detail below. Static model 160 is a word list generated for a language based on general language use, including probabilistic or other type of model of word usage in context (e.g. words in context, rather than individual words). In contrast, input bias model 170 receives and reflects a model based on detecting a user's tendency to select a tap coordinate other than the center of a key. Language model 180 receives and reflects a model based on change events (e.g., add a word, delete a word, word corrections, n-grams, and word count) from each device associated with the end user. Change events are typically processed in the order that they occurred in order to update the language model (e.g., in real-time or near real-time). However, in some embodiments, change events can be processed out of order to update the language model. For example, more important change events may be prioritized for processing before less important change events.

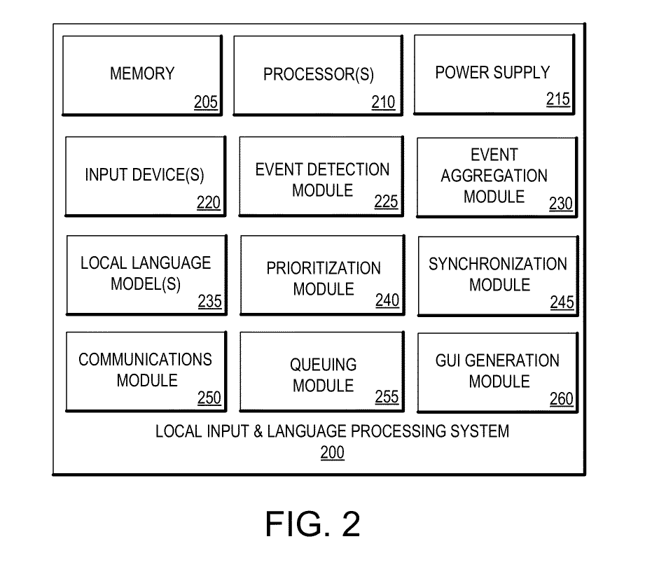

FIG. 2 illustrates a set of components for a local input and language processing system 200. According to the embodiments shown in FIG. 2, local processing system 200 can include memory 205, one or more processors 210, power supply 215, input devices 220, event detection module 225, event aggregation module 230, local models 235, prioritization module 240, synchronization module 245, communications module 250, queuing module 255, and graphical user interface (GUI) generation module 260. Other embodiments of the system may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, prioritization module 240 and queuing module 255 can be combined into a single module for prioritizing event data transfers.

Memory 205 can be any device, mechanism, or populated data structure used for storing information. In accordance with some embodiments of the present system, memory 205 can encompass any type of, but is not limited to, volatile memory, nonvolatile memory, and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), flash memory, compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205

Memory 205 may be used to store instructions for running one or more applications or modules on processors 210. For example, memory 205 could be used in one or more embodiments to house all or some of the instructions needed to execute the functionality of event detection module 225, event aggregation module 230, local models 235, prioritization module 240, synchronization module 245, communications module 250, queuing module 255, and/or GUI generation module 260. Memory 205, processors 210, and other components (e.g., input devices 220) may be powered by power supply 215 (e.g., a battery or other power source).

Event detection module 225 can use one or more input devices 220 (e.g., keyboard, touchscreen, or microphone) to detect one or more input or change events associated with each computing device 110-130. Change events arise as a result of a user's interaction with the device, such as interaction with a text-based application (e.g. email client, SMS/MMS client, word processing application) interaction with a language processing system, etc. (e.g. a change event can modify a language model such as adding a word. Examples of other events can include new word events, delete word events, mark use events, mark nonuse events, adjust quality events, delete language events, new word pair events, new n-gram events, location events, and many other events that can be used for developing a dynamic language model. The events may be derived from the user's interaction with the local device or may be automatically generated by the system.

Local models 235 can be associated with each device to locally process user inputs. These local models only incorporate the events detected with the associated device. In some cases, the models may also access any local contact lists, local e-mails, local SMS/MMS texts, and other local text-based communications for developing the local language model.

While much of the processes discussed herein may be performed solely on the local device, in some cases, event aggregation module 230, can aggregate or categorize events into a single grouping to allow communications module 250 to push the events to the master processing system 140 for processing remotely.

Prioritization module 240 prioritizes the change events detected by event detection module 225. In some embodiments, the prioritization may be based on local contextual information such as network connections, current usage rates, power levels, or user preferences. Using information about the detected events and the priority of these detected events, synchronization module 245 can send the events individually, or in the aggregate, to master processing system 140. In some embodiments, synchronization module 245 receives update instructions from master processing system 140.

Communications module 250 sends and receives any updates to and from master language and input processing system 140. In some embodiments, communications module 250 monitors the current connection type (e.g., cellular or WiFi) and can make a determination as to whether updates and events should be pushed or pulled. For example, if communications module 250 determines that a cellular connection is currently being used then any outgoing messages can be queued using queuing module 255. In addition to the current connection type, communications module may use other information such as event priority and/or user preferences when determining whether to push or pull data.

GUI generation module 260 generates one or more GUI screens that allow for interaction with a user of the system. In at least one embodiment, GUI generation module 260 generates a graphical user interface allowing a user of a computing device to set preferences, select languages, set keyboard layouts/parameters, run training applications for training the system, set device constraints, select temporary static language model additions, and/or otherwise receive or convey information between the user and the device.

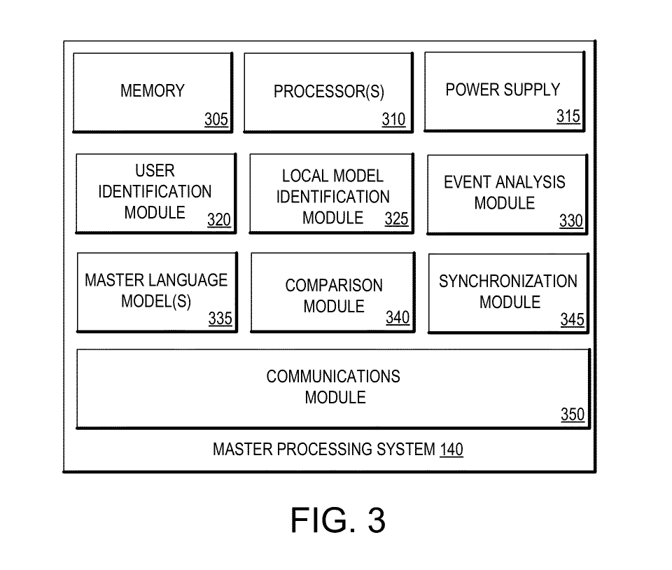

FIG. 3 illustrates a set of components for master processing system 140. According to the embodiments shown in FIG. 3, master processing system 140 can include memory 305, one or more processors 310, power supply 315, user identification module 320, local model identification module 325, event analysis module 330, master models 335 (which may include, for example, a static model, an input bias model, and/or a language model), comparison module 340, synchronization module 345, and communications module 350. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, the functionality of user identification module 320 and local model identification module 325 may be incorporated into a single module.

Memory 305 can be any device, mechanism, or populated data structure used for storing information as describe above with reference to memory 205. Memory 305 may be used to store instructions for running one or more applications or modules on processors 310. For example, memory 305 could be used in one or more embodiments to house all or some of the instructions needed to execute the functionality of user identification module 320, local model identification module 325, event analysis module 330, master models 335, comparison module 340, synchronization module 345, and/or communications module 350.

User identification module 320 can be configured to identify the user. In accordance with various embodiments, a variety of methods may be used such as, but not limited to, log in credentials, telecommunication device identifiers, voice identification, visual recognition, and/or other techniques for identifying users. The same or different identification methods may be used at each device to identify the user when the user accesses the system.

As events are received from the local input and language and model associated with an individual (e.g. keyboard input events), event analysis module 330 determines how the events should be processed and applied (e.g., sequentially based on a time stamp or based on an assigned event priority) to the master input and language models 335. In some embodiments, the changes to the master models 335 can be tracked using a change log in a SQL database. In other embodiments, the changes are stored in an on disk change log. In addition to the events received from the local devices, other off-board personal data, such as website data, social networking data, social networking friend data (such as communications with friends), information from personal computing devices, data from Internet accessible documents (e.g., Google docs), and others may be utilized in building the master models.

Comparison module 340 determines the current state of any of the user's local models as compared to the current master models. Using the state information that is determined by comparison module 340, information synchronization module 345 can determine whether to send updates (e.g., in batches) using communications module 350 or request that an entire local model be replaced. But note that some embodiments of the invention perform all actions locally and thus need not employ components to facilitate communication with the master processing system 140 (e.g., can omit some or all of comparison module 340, synchronization module 345, and communications module 350).

### Input Bias and Language Feedback System

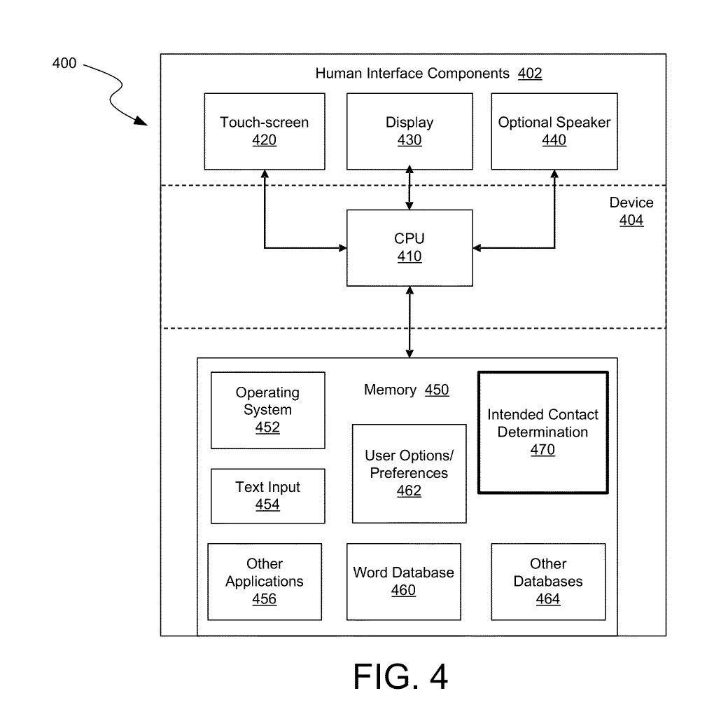

FIG. 4 illustrates a block diagram of a computing device 400 on which embodiments of the present invention can be utilized. The computing device 400 may be a mobile device, smart-phone, tablet computer, net-book, mobile GPS navigation device, remote control, fixed telephone or communications console or apparatus, surface or tabletop computer, overhead image projector, desktop computer, e-reader, ATM machine, vending machine, or any other device having a keyboard (e.g., any device having a physical keyboard or a virtual keyboard). The computing device 400 includes various hardware and/or components configured to provide information to a typing correction system and perform typing corrections for users of the computing device 400.

The device 400 includes a touch-screen 420 or other input component that provides input to a processor 410, such as input notifying the processor 410 of contact events when the touch-screen is touched. The touch-screen may include or communicate with a hardware controller, such as a touch-screen driver, that interprets raw signals received from the touch-screen and transmits information associated with the contact event (e.g., indication of a button or key press, X-Y coordinates of a point of contact (such as from a finger or stylus touch on a touch screen, touch pad, or graphics tablet), a request by a user to press a physical or virtual key, the current position of a pointing input device, area of contact, pressure, duration, and so on) to the processor 410. For example, the hardware controller may transmit information associated with a variety of pointing devices, including a mouse, a trackball, a joystick or analog stick, a pointing stick or nipple mouse, a roller mouse, a foot mouse, a palm mouse, a light pen, a light gun, a positional gun, a laser pointer, a gyroscope or gyroscopic mouse, an accelerometer, an eye tracking device, a video tracking device, a stylus, and so on. The processor 410 communicates with a hardware controller or driver associated with a display 430 to display information (e.g., letters of contacted keys on a displayed keyboard) associated with detected contact events. The display 430 may be integrated into computing device 400, or may be a stand-alone device. Example displays 430 include a touchscreen display, a flat panel display, a cathode ray tube, an electronic ink display, a head-mounted display, a liquid crystal display, a light-emitting diode display, a plasma panel display, an electro-luminescent display, a vacuum fluorescent display, a digital projector, a laser projector, a heads-up display, and so on. The device 400 may include a speaker 440 that provides appropriate auditory signals to assist a user in navigating a displayed keyboard or other displayed component.

The processor 410 may communicate with data or applications stored in a memory component 450 of the device 400, which may include a combination of temporary and/or permanent storage, and both read-only and writable memory (random access memory or RAM), read-only memory (ROM), writable non-volatile memory such as FLASH memory, hard drives, floppy disks, SIM-based components, and so on. The memory component 450 includes various program components or modules, such as an operating system 452, various text input applications 454, and other applications or programs 456, such as applications downloaded to the device 400. Further, the memory component includes a typing correction component or system 470, to be discussed in greater detail herein.

The text input application may be a key tap application, a gesture or contact movement application, or any other application that facilitates the entry of text from a user. The text input application may cause the device to display a keyboard via touch-screen 420 and receive input via a displayed keyboard. The keyboard may be a physical keyboard or a virtual keyboard, such as any keyboard that is implemented on a touch-sensitive surface, such as a keyboard presented on a touch-sensitive display, a keyboard imprinted on a touch-sensitive surface, and so on. Example keyboards include a keyboard displayed on a monitor, a keyboard displayed on a touch screen, a keyboard optically projected onto a flat or curved surface, or a physical keyboard with electronically changeable key symbols integrated into the keys, and so on. Further details regarding suitable text input applications may be found in commonly-assigned U.S. Pat. No. 7,542,029, issued on Jun. 2, 2009, entitled SYSTEM AND METHOD FOR A USER INTERFACE FOR TEXT EDITING AND MENU SELECTION, which is incorporated by reference in its entirety. Further details regarding the present invention may be found in commonly-assigned U.S. patent application Ser. No. 13/366,225, filed on Feb. 13, 2012, entitled CORRECTING TYPING MISTAKES BASED ON PROBABILITIES OF INTENDED CONTACT FOR NON-CONTACTED KEYS; and commonly-assigned U.S. patent application Ser. No. 12/186,425, filed on Aug. 5, 2008, entitled A PROBABILITY-BASED APPROACH TO RECOGNITION OF USER-ENTERED DATA, each of which are incorporated by reference in their entirely.

The memory component 450 also includes data storage components, such as a word database 460 for the text input applications 454 (e.g., a local language model), a user data database 462, and other databases 464 that provide and/or store information for applications executed by the device 400. The word database may include probabilistic or other model of word usage in context, as noted herein.

The device 400 may include other components (not shown) that facilitate operation of the device and its various components, including other input or output components, a radio and/or other communication components, power components, a subscriber identity module (SIM), and so on. In general, the device 400 may store or contain any and all components, modules, or data files required or used in performing typing corrections for text input applications provided by the device 400.

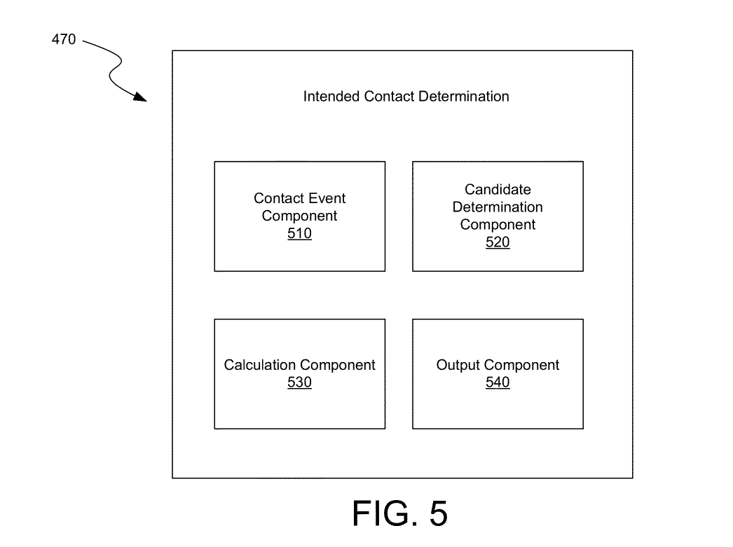

As discussed herein, the device 400 may include or store an intended contact determination component that provides information, such as probabilities associated with a contact event being an intended contact event, to a text input application 454, such as a key tap or path based text input application. FIG. 5 is a block diagram illustrating an intended contact determination component 470 employed by device typing correction system or other system facilitating the input of text to a device. The intended contact determination component 470 includes a contact event component 510 configured and/or programmed to receive information identifying and/or associated with a contact event at a contacted, pressed, or otherwise activated key of a displayed or other touch-sensitive keyboard, such as a virtual keyboard, physical keyboard, and so on. For example, the contact event component 510 may receive coordinate information (e.g., values for X and Y coordinates) associated with a contact event, or other information that indicates a location of contact during a contact event.

The intended contact determination component 470 also includes a key candidate determination component 520 that identifies candidate keys, which include keys other than the contacted key, and which may have been intended to be contacted by a user of the keyboard. For example, the candidate keys may be neighboring keys, keys adjacent to a contacted key, keys proximate to the adjacent keys, keys on a path of movement over the keyboard, and so on. The key candidate determination component 520 may, therefore, determine a group of candidate keys as keys the user possibly intended to tap or move over on the keyboard.

A calculation component 530 receives information from the key candidate determination component 520, such as a group or list of candidate keys, and calculates and/or determines probabilities that one or more keys adjacent or proximate to a key receiving a contact event (e.g., key tap or path movement) within the key was the intended key for the contact event. The calculation component 530 transmits the calculated probabilities and/or other information to an output component 540, which provides the information to components of the typing correction system, in order to reduce a number of candidate words considered by a text input application during a contact event, among other benefits.

For example, a touchscreen input driver associated with a touch-screen 420 of a mobile device 400 transmits contact event information to the intended contact determination component 470, which performs one or more of the routines described herein to determine intended contact probabilities associated with keys adjacent or proximate to a key activated during the contact event. The intended contact determination component 470 may then provide the determined probabilities to a typing correction system, such as a system contained by or employed by the text input application 454.

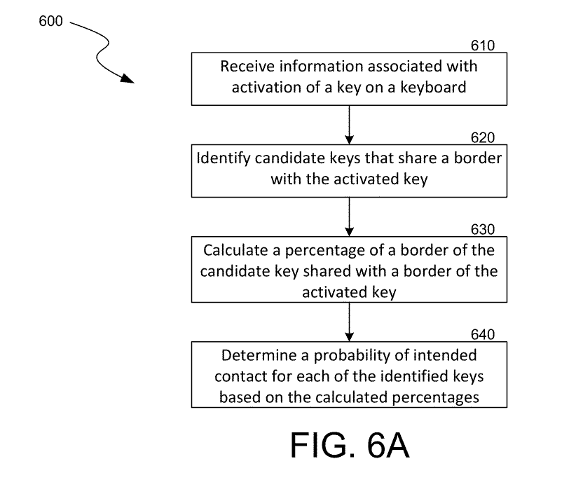

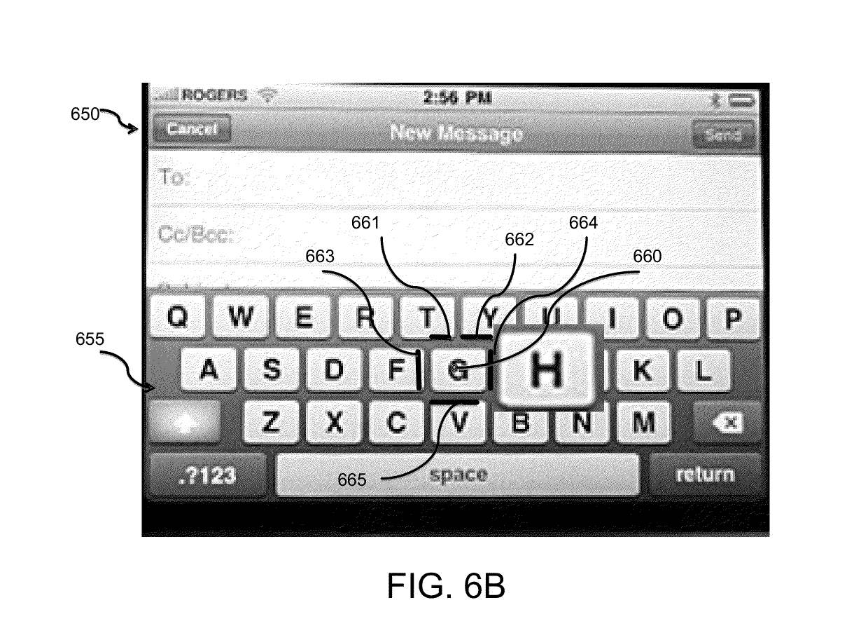

In some embodiments, the intended contact determination component 470 may provide probabilities based on a sharing of borders between keys. FIGS. 6A-6B are, respectively, a flow diagram and accompanying schematic diagram illustrating a routine 600 for determining intended contact probabilities during a contact event based on shared borders between candidate keys and a contacted key.

In step 610 of FIG. 6A, a routine 600 receives information associated with a tap or contact event or activation of a key on a keyboard. The routine 600 may receive information identifying the key activated during a contact event while a user is inputting text. For example, FIG. 6B depicts a touch-screen 650 having a displayed keyboard 655 with a contact event occurring at a point of contact 660 within the boundaries of the G key.

In step 620, the routine 600 identifies candidate keys as the keys that share a border with the activated key. Following the example, FIG. 6B depicts five keys that share a border with the G key: the H key and the F key located on the same row as the G key, the V key directly below the G key, the T key above the left corner of the G key, and the Y key above the right corner of the G key.

In step 630, the routine 600 calculates a percentage of a border that an activated key shares with a border of a candidate key. Following the example, FIG. 6B depicts the various borders shared between the G keys and the adjacent keys. In the example, the T key shares 15% of the G key's border 661, the Y key shares 15% of the G key's border 662, the F key shares 20% of the G key's border 663, the H key shares 20% of the G key's border 664, and the V key shares 30% of the G key's border 665.

In step 640, the routine 600 determines a probability of intended contact for each of the identified keys based, at least in part, on the calculated percentages. The routine 600 may determine the probability based on any number of equations or algorithms, such as:

Probability=(multiplying factor for non-activated key)*(percentage of shared border)

Thus, if the multiplying factor is 0.7 for all non-activated keys, then the following probabilities of intended contact would be determined for the contact event depicted in FIG. 6B:

Probability of T key=0.7(0.15)=0.105

Probability of Y key=0.7(0.15)=0.105

Probability of F key=0.7(0.2)=0.14

Probability of H key=0.7(0.2)=0.14

Probability of V key=0.7(0.3)=0.21

Of course, other equations, variables, or factors may be employed. For example, the position of a key, such as its horizontal or vertical position relative to an activated key, may be considered when determining a probability of one or more adjacent keys. In some cases, the routine 600 and other routines described herein may only consider certain candidate keys that share a border with an activated key, such as the keys within the same row as an activated key. In some cases, the routine 600 may provide a certain multiplying factor for adjacent keys in the same row as an activated key, and a different multiplying factor for keys above or below an activated key.

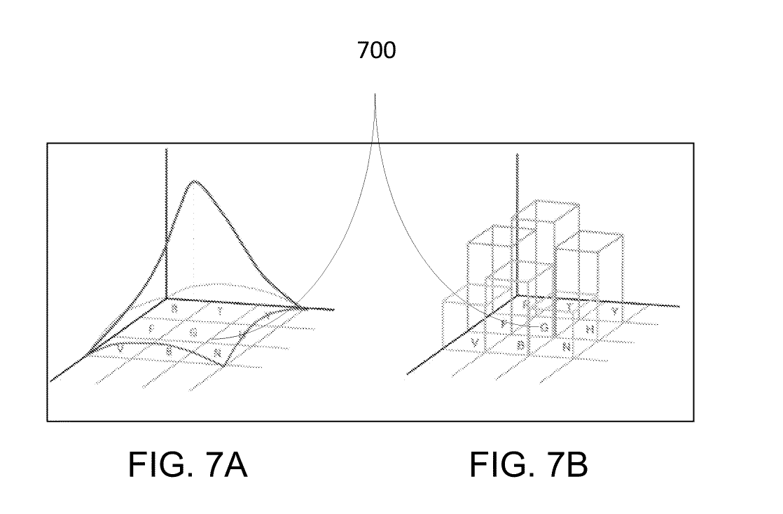

FIG. 7A illustrates an example in which a part of a QWERTY keyboard 700 is shown. Assuming a typical user (not shown) intends upon pressing or hitting the G key, the user would most likely have a direct hit upon the G key. However, the user may hit other keys in close proximity to the G key albeit with a lower probability. This scenario occurs most often when the keyboard is too small to accommodate the user's entering means such as fingers. Alternatively, the user may just be careless or has a physical limitation preventing an accurate key entry. As can be seen, FIG. 7A gives a representation of a continuous probability density centered on the G key. The slope of the probability distribution could be at a power of 2 or 4, depending upon the application (e.g. size of keyboard), though other distributions are possible, such as Gaussian. While not shown, the distribution or decay may extend beyond the neighboring keys to also include farther neighboring keys (albeit at an even lower probability distribution).

Referring to FIG. 7B, a discrete probability density based upon FIG. 7A is shown. Since pressing a key yields the same input regardless of precisely where the key was struck, such a discrete probability density is more useful. As can be seen, intending upon hitting G key and actually hitting the G key typically has the highest probability. Other keys proximate to the G key have relatively low probabilities. Such a discrete probability density may be invoked with respect to use of the language feedback model discussed herein.

FIGS. 7A-7B generally assume that a user is entering text on a keyboard (physical or touch screen, QWERTY or otherwise). The assumption is that the user is entering a word in a predetermined dictionary. The algorithm or a method suitable for computer implementation will attempt to discern the word that the user intends on entering, whereby allowing for the user to make typing errors based upon probability. The primary assumption is that the user does not make ‘large’ mistakes, but may make many ‘small’ mistakes.

As noted above, the system may use a combination of a static model, an input bias model, and/or a language model, each of which will now be discussed separately.

### Static Model

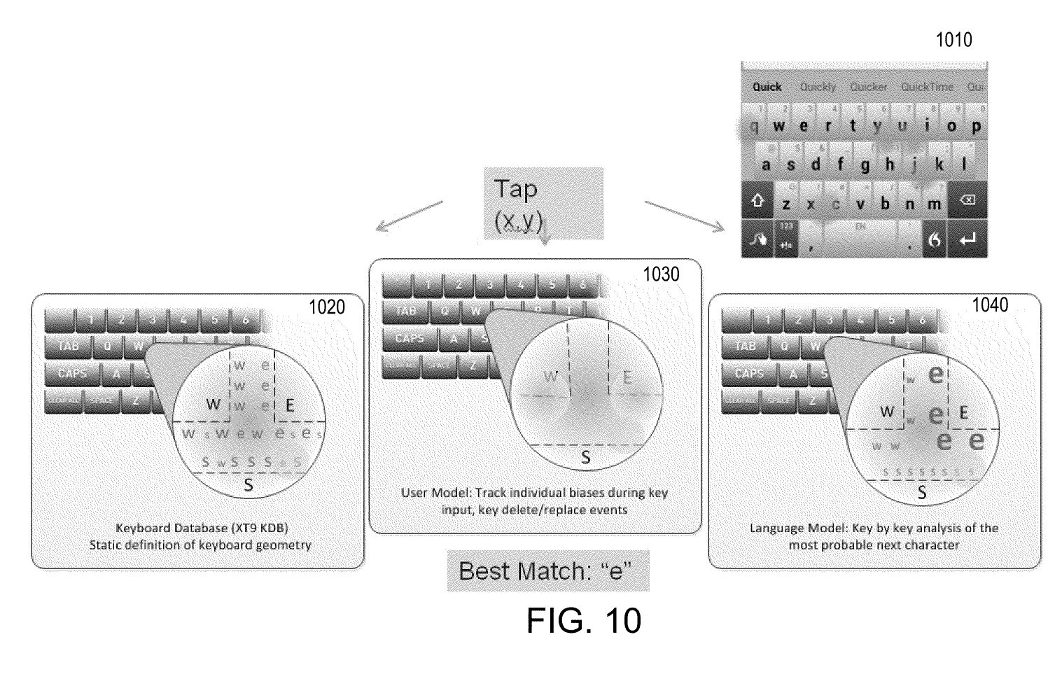

Classic regional keyboard models (such as XT9) are static probability models based on physical keyboard properties such as key size and distance between keys. For example, in a classic regional keyboard model, a touch coordinate around the G key on a QWERTY keyboard will return G plus neighboring or regional matches T, Y, F, H, V, and B. The probabilities for returning one of the regional matches depends on where in the general area of G that the touch took place. For example, if the user taps a coordinate between G and B, the keyboard may return a G if the tapped coordinate lies closer to the center coordinate of the G key than to the center of the B key. On the other hand, if the tapped coordinate lies closer to the center coordinate of the B key than to the center of the G key, then the keyboard instead may return a B. Under classic regional keyboard models, the layout of the keyboard will produce the same result for an identical tap coordinate. For example, FIG. 10 illustrates tap coordinates 1010 on a touch keyboard. Expanded section 1020 shows a static keyboard geometry for a classic keyboard, in which the results for each tap coordinate remain the same under the particular keyboard geometry.

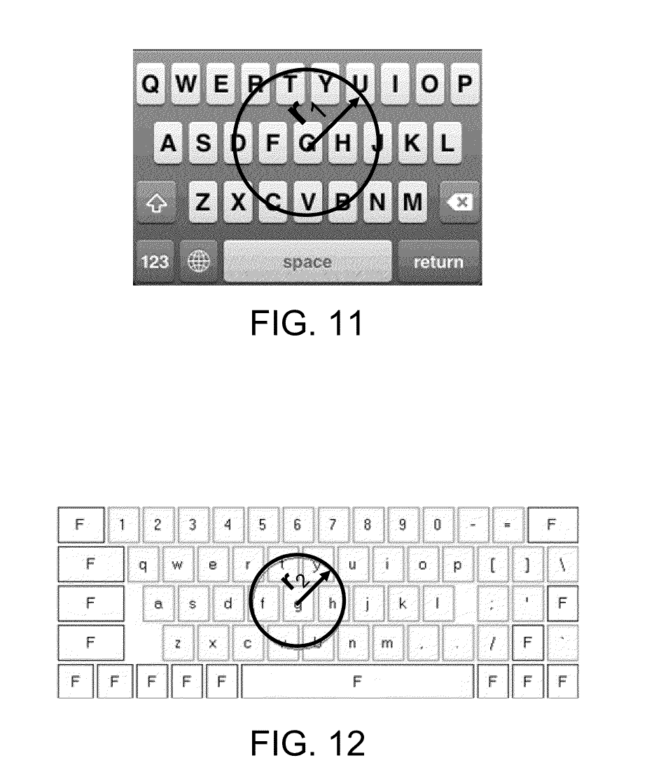

A static model may calculate the probability that a particular key has been selected by a variety of different methods. For example, in one embodiment, the static model calculates the probability that a particular key has been selected based on the distance from the center of a key to a point of interest, such as a touch screen tap point or a point that is part of a trace according to the formula P=1−Distance/Radius. In this example probability formula, the radius may be varied in accordance with multiple factors, including the physical geometry of the keyboard layout. A radius may be selected that represents the smallest radius that may still yield the expected neighbors for a tap in the center of a key. For example, referring to a small keyboard layout of FIG. 11, which may be provided on a mobile phone and which has vertically aligned rectangular keys, the G key has expected neighbor keys T, Y, F, H, C, V, and B. Selecting a radius r₁ includes the expected neighbors (T, Y, F, H, C, V, and B), which lie fully or partially within the radius, but also includes the D and J keys, which are not neighbor keys for G. As a result, the selected radius r₁ is an inflated radius because it may return more keys than is desirable.

In another example, FIG. 12 illustrates a larger keyboard layout having keys that are square shaped and are not vertically aligned. Here, the G key has expected neighbor keys T, Y, F, H, V, and B. Selecting a smaller radius r₂ results in the inclusion of only the expected neighbors (T, Y, F, H, V, and B), which lie fully or partially within the radius. As a result, radius r₂ may be more ideal than inflated radius r₁ because r₂ includes only the expected neighbors while excluding undesirable keys. The smaller radius r₂ may result in a noticeable difference in prediction quality (e.g., smaller radius r₂ may be less ambiguous) as well as performance speed (e.g. fewer probabilities to compute). In general, an increase in radius results in increased computational effort and decreased performance. These effects may occur for key pressing when the radius picks up unexpected neighbors also from the key centers. The effects may be even more pronounced in trace and tapping, which differs from pressing a key because positions that are not on a key center are likely to pick up even more neighbors (resulting in a larger ambiguous set) due to the larger radius.

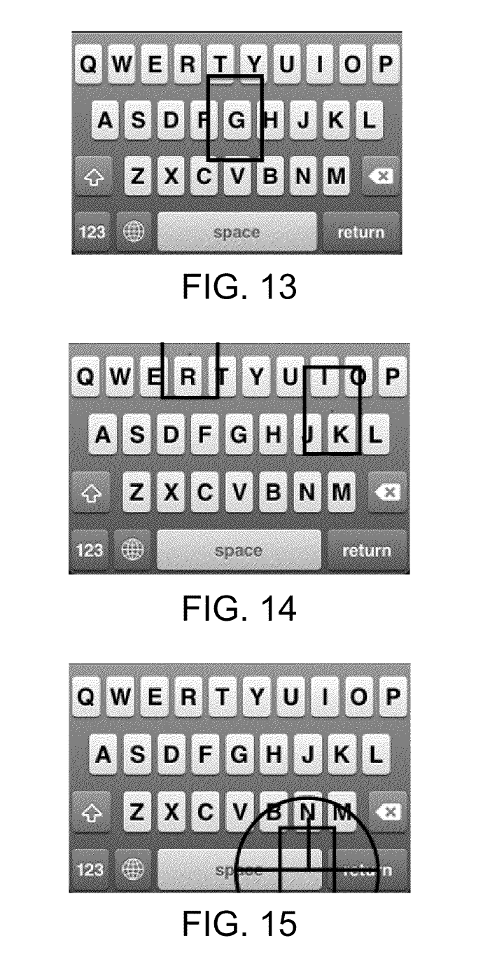

In another embodiment, a static model calculates the probability that a particular key has been selected based on the area that the key overlaps with a touched area according to the formula P=Overlap/Touch-Area. For area-based calculation, the system calculates an optimum touch-area. The system may determine key neighbors by specifying a touch-area that is larger than a key (for example, two to four times the size of a key), centering the touch-area over the key, and determining other keys that fully or partially overlap with that touch-area. A median size of a touch-area may be used to accommodate various keyboard layouts having keys of different sizes. Further, the overlapping keys may be the expected neighbors. In the example keyboard layout of FIG. 13, the expected neighbors for the G key would be T, Y, F, H, C, V, and B. Using the touch-area depicted in FIG. 13 and identifying the overlapping areas generates the expected neighbors and nothing else—as opposed to inflated radius r₁ discussed above. FIG. 14 illustrates further examples of using a touch-area for a tap, including touch-area 1405 (which overlaps the R, E, and T keys) and touch area 1410 (which overlaps the I, O, J, and K keys).

By finding neighbor keys using an area that is larger than a key (for example, two to four times the median size), it is possible to find the minimum touch-area that still may generate the same neighbors with overlap. This minimum touch area may yield the smallest and strictest ambiguous sets (for area based probabilities). This minimized touch-area may be too small for a good user experience, depending on the actual size of the “physical” keyboard displayed on the device. To improve the user experience in this regard, an Original Equipment Manufacturer (OEM) setting may be used to specify the physical size of the keyboard. The OEM setting may be used as a basis for estimating an optimal size for the touch-area related to finger top size. For example, it may not be advantageous to allow the touch-area to exceed twice the median size of the touch-area of FIG. 13.

For keyboard layouts with odd key sizes, area-based calculations may be likely to produce more expected results. For example, as illustrated in FIG. 15, the space key is an odd sized key relative to the alphanumeric keys on the QWERTY keyboard. FIG. 15 illustrates a tap position on the right side of the space key. The center of the space key lies in a position relatively distant from the tap position, while several other keys have a center lying closer to the tap position. Given the tap position, it is likely that the tap resulted from a finger that likely did not overlap with any key other than the space key, thereby indicating a likelihood that the space key was selected intentionally. In this case, a radius-based calculation would indicate a selection of the N, B, M, and return key before the space key, and a smaller radius centered on the space key may even omit the space key altogether for this example input. However, by using an area overlap based calculation, the system can indicate the space key as the most likely intended key while also retaining the N, B, M, and return keys in the set.

### Input Bias Model

The input bias model is based on collected data correlating to actual input with user events such as delete, auto-accepting a candidate, and explicitly accepting a candidate. The input bias model can learn new “hot areas” for keys in light of multiple factors, including key center offset and sloppiness. A hot area may comprise a protected area (i.e., an area of the QWERTY keyboard that, if selected, will consistently result in the selection of a particular key) plus areas of high probability for a given key.

To calculate bias scores for a given tap position (coordinate), the system may sum up events related to the respective key regions, taking the event quality and distance into account. For example, at a given tap position, the system may determine the probability for each key that neighbors the current tap position. The neighboring key with the highest probability generally is assigned to the tap position such that a user who taps that particular tap position will receive as output the key having the highest probability. As user events occur (e.g., accepting an autocorrect word; manually choosing a candidate word; deleting and replacing text), the system recalculates the bias scores for the given tap position to take those user events into account.

In one embodiment, the input bias model is adapted to dynamically change the keyboard landscape such that the keyboard will not necessarily produce the same result for an identical tap coordinate. Rather, the keyboard landscape is adapted to account for key offset bias that occurs when the user has a tendency to select a tap coordinate that would otherwise return an unintended key. For example, key offset bias may result from a tendency to select tap coordinates lying above the intended key or between two intended keys (as illustrated in FIG. 10 at expanded section 1030), or may result from a tendency to select tap coordinates corresponding to the location where a user taps the keyboard, the location where a user rolls a finger over the keyboard, or the location from which a user lifts a finger off of the keyboard.

The system adapts the keyboard landscape by monitoring a series of events and, when an event occurs, changing the respective probabilities of one or more tap coordinates that correspond to the detected event. For example, the system may alter the keyboard landscape in response to a detected delete event. A delete event may occur for example when a user intends to enter the word TAG. The user first selects the letter T followed by the letter A. However, when the user attempts to select the letter G, the user's finger selects tap coordinates that lie between the intended letter G and the unintended neighboring letter B. Based on the existing keyboard landscape, the system may interpret the selected tap coordinates as an intention for the user to select B (resulting in the word TAB) when the user actually intended to select the letter G (resulting in the word TAG). The user then notices the error and corrects it by deleting the letter B and replacing it with the letter G. The system tracks the deletion of the letter B and corresponding replacement with the letter G. The system then increases the weight assigned to the letter G at the appropriate tap coordinates and/or decreases the weight assigned to letter B at the appropriate tap coordinates. As a result, the system will subsequently, upon receiving the same or similar tap coordinates between the letters B and G, will more likely to return a G rather than a B, particularly when the two previously input letters were T and A (as explained herein). (While a user may delete a letter manually, the system may also accept voice commands from the user reflect a correction such as a deletion.)

As another example, the system may alter the keyboard landscape in response to a detected manual word selection event. A manual word selection event may occur for example when a user intends to enter the word PROCESSOR The user may enter the letters PROD, and the system may present the user with a drop-down list of potential candidate words. In the current example, the drop-down list may include candidate words PRODUCT, PRODUCE, PROFESSOR, PROCESSOR, and PROXY. If the user selects the candidate word PRODUCT or PRODUCE then the system does not alter the keyboard landscape because the system recognizes that the first four letters (i.e., PROD) were entered correctly because they are contained verbatim in the selected candidate word. However, if the user selects the word PROFESSOR from the candidate list, then the system recognizes that the D was entered incorrectly (i.e., there is no D in the word PROFESSOR). In response, the system alters the keyboard landscape to assign a greater weight to F at the selected tap coordinates and a lower weight to D at the selected tap coordinates when a user selects tap coordinates that lie between F and D. Similarly, if the user selects the word PROCESSOR from the candidate list, then the system recognizes that the D was entered incorrectly and alters the keyboard landscape to assign a greater weight to C at the selected tap coordinates and a lower weight to D at the selected tap coordinates when a user selects tap coordinates that lie between C and D. Also similarly, if the user selects the word PROXY from the candidate list, then the system recognizes that the D was entered incorrectly and alters the keyboard landscape to assign a greater weight to X at the selected tap coordinates and a lower weight to D at the selected tap coordinates when a user selects tap coordinates that lie between C and D.

In addition, the system may alter the keyboard landscape in response to a detected automatic word selection event. An automatic word selection event may occur when a user enters a word that is not recognized by the system and is then automatically changed to a similar word that is recognized by the system. For example, a user may intend to spell the word REFRIGERATOR. However, when the user attempts to select the letter O, the user's finger selects tap coordinates that lie between the intended letter O and the unintended neighboring letter I. Based on the existing keyboard landscape, the system may interpret the selected tap coordinates as an intention for the user to select I (resulting in the word REFRIGERATIR) when the user actually intended to select the letter ‘o’ (resulting in the word REFRIGERATOR). The system may employ an autocorrect function to automatically change the letter I to O. If the user rejects the autocorrected word (i.e., the user reverses the autocorrect), then the system may leave the keyboard layout unaffected because it recognizes that the I was intentionally selected. Alternatively, the system may increase the weight assigned to the letter I at the selected tap coordinates and/or decrease the weight assigned to letter O at the selected tap coordinates. As a result, a subsequent user who selects the same or similar tap coordinates between the letters O and I is even more likely to input an I rather than an O. If, on the other hand, the user accepts the autocorrected word (i.e., the user does not reverse the autocorrect), then the system increases the weight assigned to the letter O at the selected tap coordinates and/or decreases the weight assigned to letter I at the selected tap coordinates. As a result, a subsequent user who selects the same or similar tap coordinates between the letters O and I is more likely to input an O instead of I.

Normally the system sees a touch tap as at least two to three different events. First the finger comes down (touch down) to touch one or more characters on the screen. At this point the user feedback might include a small pop-up above the position to indicate the key by showing the one or more characters being touched. Moving the finger (touch move) while down could potentially trigger a different popup if it passes to a new key. When the finger is released from the screen again (touch up), the actual user input may then take place and one or more characters may be added to the text. Showing a popup does not change the state of the text; however, the input step does change the state of the text. A person of ordinary skill in the art will appreciate that the user input may additionally or alternatively take place at the touch down, touch move, or touch up steps.

User input may also be described in terms of a touch and roll motion. The input bias model may be adapted to identify a touch and roll motion of a user that tracks when the user's finger makes contact with the touch keyboard, rolls on the touch keyboard, and/or lifts off of the touch keyboard. The system may compare the user-selected key to the tap coordinates corresponding to the location at which the user's finger initially touches the touch keyboard, the location at which the user's finger rolls across the keyboard, and/or the location at which the user's finger lifts off of the touch keyboard. The system may use the comparison to identify a tendency of the user to select intended tap coordinates at the beginning, middle, or end of the user's touch and roll gesture. Once the system has identified the user's tendencies, the system may adjust the weighting according to the identified tendencies to increase the likelihood that the intended key is returned.

The system may identify one or more protected areas of a key that will consistently return a particular key when the user taps the protected area, such as an area centered on each key. For example, the G key may have a protected area that is centered on the G key such that a G will always be returned any time a user taps on this centered protected area, regardless of the probability that the system generates for an input. When the keyboard landscape is altered, the input area of a key may also be altered or augmented to include not only the protected area, but also a neighboring region. For example, while the protected area for the G key may be centered on the G key, the system may extend or reallocate the protected area to also include the lower right of the G key, or into a “free area” between keys (between protected areas). In this fashion, any time a user taps on the virtual keyboard at coordinates to the lower right of the G key, the system will return a G.

The system may reallocate, expand or augment a protected area of a key to prevent other keys from being assigned to the coordinates encompassed in the reallocated, expanded or augmented protected area. For example, if the system assigns a protected area for the G key to also include the lower right of the G key, then the system would not allow any other key (such as the B key) to be assigned to the same protected area that is assigned to the G key. Theoretically, the maximum probability for a key could move towards a different key's protected key area, but because of the protected key allocations, the system prevents one key from moving into another key's protected area. By using protected areas, the system ensures that each key has at least one area of the keyboard that is dedicated for input of that particular key, even if the key has a very low probability.

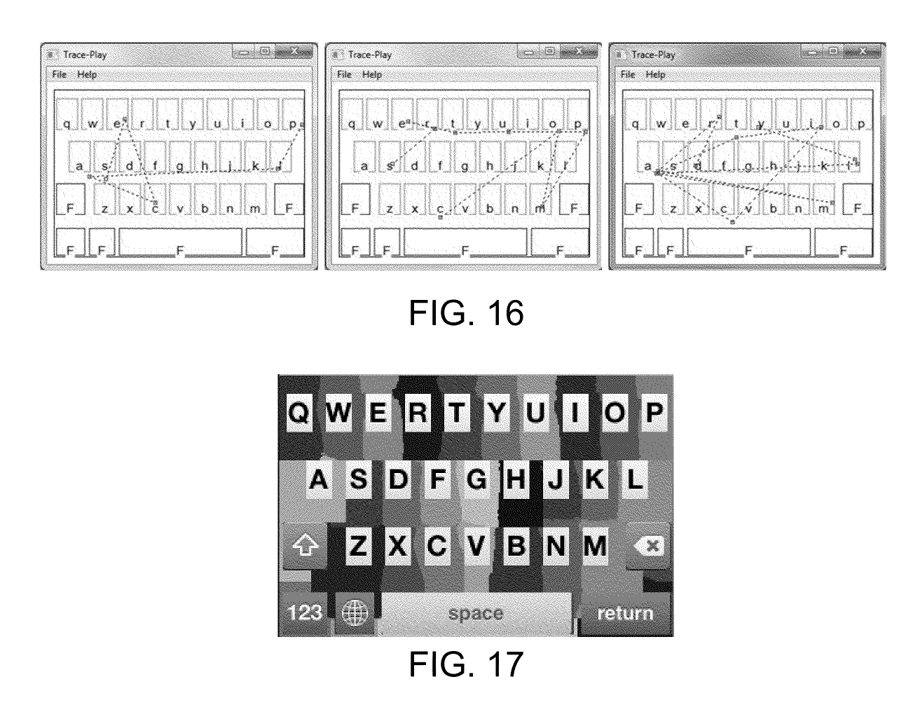

In terms of input bias, the amount of error or bias may be specified as a range of fractions of an ambiguity box of a particular size (for example, the ambiguity box is usually about twice the size of a normal key). The bias may also be specified as fractions for X- and Y-axis bias. The bias may move the key center that is the basis for the normal error. FIG. 16 illustrates the input of sample words with relatively heavy bias (error 10%-40% and bias of 20% X and 45% Y). For example, as illustrated by the shading behind each key shown in FIG. 16, such a bias can demonstrate a tendency to tap coordinates to the lower right of an intended key.

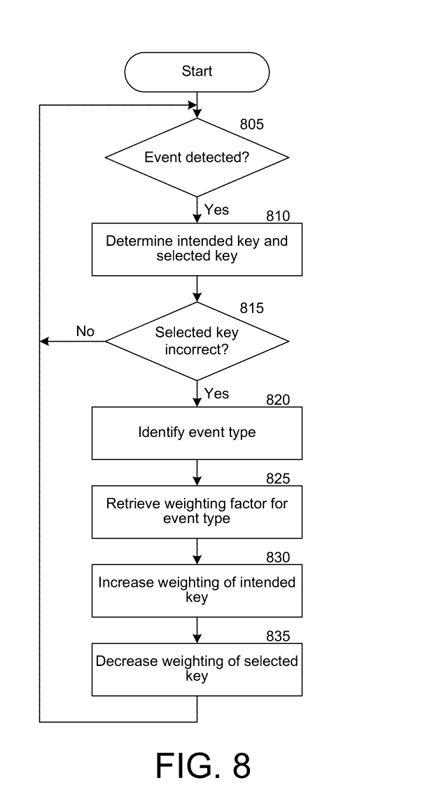

FIG. 8 is a flowchart illustrating a flow process for altering a keyboard landscape in accordance with the input bias model described herein. At step 805, the system detects an input event. At step 810, the system determines the key that was intended and the key that was actually selected. The selected key is compared to the intended key at step 815. If the selected key matches the intended key, then the system does not alter the current keyboard landscape and instead returns to step 805 to continue monitoring events as events are detected. Returning to step 815, if the selected key does not match the intended key (e.g. the user provides such an indication), then the system identifies the type of detected event (e.g., delete events, manual word selection events, or automatic word selection events) at step 820 and retrieves a weighting factor for the retrieved event type at step 825. A person or ordinary skill will appreciate that different detected events may have the same or different associated weighting factors. In this fashion, the system enables certain types of events to have a larger, a smaller, or the same impact on the keyboard landscape relative to other types of events. The system increases the weighting of the intended key at the selected tap coordinates by the retrieved weight factor (step 830) and/or decreases the weighting of the selected key at the selected tap coordinates by the retrieved weight factor (step 835). The system then returns to step 805 to continue monitoring events as events are detected and altering the keyboard landscape as detected events warrant.

A person of ordinary skill will appreciate that the input bias model may be extended beyond a traditional alphanumeric keyboard to other input modes such as gestures (e.g., a finger swipe across a touchscreen).

### Language Model

The language model provides feedback from selection list building, using words with completion to predict the next character or key to be entered. The language model may base feedback on using words with zero stem distance (i.e., words that start like the exact letters entered) or using words in the list (i.e., may use words that have been corrected from the letters entered). As an alternative, a language specific character n-gram model may be used, although this option may require more memory and processor cycles. Language models may be interpolated to get a total score for choosing an exact letter or word match.

The language feedback model provides a conditional probability for the next tap coordinate. The system may determine the probability of the next key or the next word through a pure character n-gram model (e.g. from the local language model), through actual candidate-list content from a big word based n-gram model (e.g. from a master language model), or through a combination of both. When determining the probable next key or word, the system may base its determination on current user input with or without autocorrection. For example, the system may base the determination of the next character or word on GAMD (as the user may enter inadvertently) or may first correct GAMD to GAME, and then base the determination of the next character on the corrected word GAME (particularly if the prior words entered were WON THE, thus the multi-word context increases the probability that the next letter is E.) Note that the system may system may present the correct word being entered while in process, instead of doing a correction at the end.

In addition, the system may augment the virtual size of the key corresponding to the most probable next tap coordinate, thereby allowing the user to more easily select the correct key. In other words, the virtual x-y dimension or area of the most probable next key are increased to increase the probability that the user will tap within that area. When adjusting for the language model, the system need not have to visibly show to the user that the ‘size’ of key has changed, so that in the phrase WON THE GAME would invisibly have the E key effectively bigger. A person of ordinary skill will appreciate that the system may distinguish the appearance of the next probable key in a variety of additional ways, including changing the color of the next probable key, highlighting the next probable key, or animating the next probable key. The language feedback model adjusts the keyboard landscape in real time, thereby altering the keyboard geometry (depicted in expanded section 1040 of FIG. 10) each time a key selection is input.

If the user selects the predicted next key, then the system may increase or leave unchanged the weighting associated with the predicted next key. If, however, the user selects a key that differs from the predicted next key, then the system may decrease the weighting for the predicted next key and increase the weighting for the key that was actually selected. For example, if a user enters CRUS, the system recognizes that there is a high probability that the next key entered will be an H in order to form the word CRUSH. As depicted in FIG. 6B, this information may then fed back to the keyboard to make the H key appear bigger on the keyboard in relation to the surrounding keys so that the user has a better chance of selecting the H key. If the user does select the H key to form the word CRUSH, then the system either leaves the weighting unchanged or increases the weighting of the H key. If the user does not accept the predicted H key but instead selects that T key to form the word CRUST, then the system may decrease the weighting of the H key and increase the weighting of the T key.

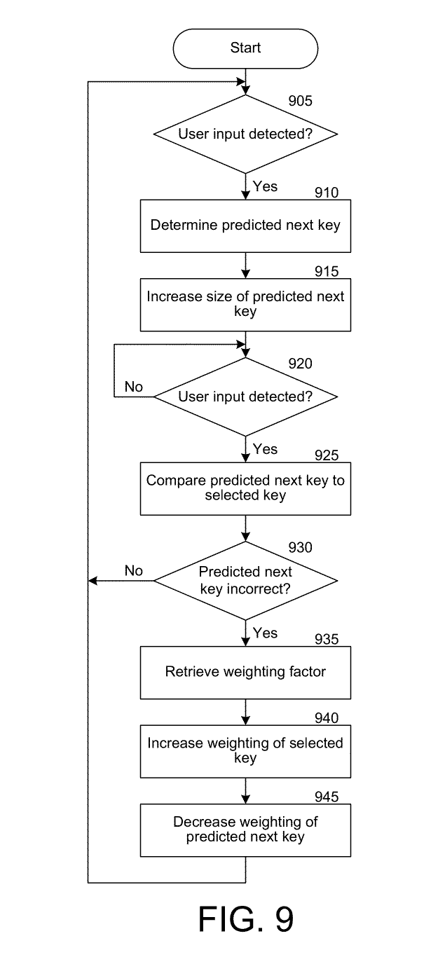

FIG. 9 is a flowchart illustrating a flow process for altering a keyboard landscape in accordance with the language model described herein. At step 905, the system detects user input via the keyboard. At step 910, the system determines the predicted next key based on the input that has been entered by the user. The next predicted key is then enlarged on the keyboard at step 915. The system then checks for additional user input at step 920. If no additional user input is detected, the system returns to step 920 to continue monitoring for user input. If additional user input is detected, then the system at 925 compares the predicted key to the actual key that was selected by the user. At step 930, if the predicted key and the entered key match, the system returns to step 905 to monitor user input and determine additional predicted next keys as the user continues to provide input. Returning to step 930, if the predicted key and the entered key do not match, the system retrieves a weighting factor at step 935, increases the weighting of the selected key by the retrieved weighting factor at step 940, and/or decreases the weighting of the predicted key by the retrieved weighting factor at step 945. The system then returns to step 905 to monitor user input and determine additional predicted next keys as the user continues to provide input. A person of ordinary skill will recognize that, in addition to predicting the next input key, the system describe herein may also predict the next word instead of or in addition to predicting the next input key. Note that the system may adjust weightings on a letter-by-letter basis. A person of ordinary skill in the art will appreciate that the language model may use multiple different weighting factors. For example, the language model may use a first weighting factor when increasing a weighting, and a same or different weighting factor when decreasing a weighting.

### Combined Models

In the disclosed system, one or more language models may be combined to provide a better user experience. For example, the system may use an interpolation that employs a mix of 25% of the static model, 25% of the input bias model, and 50% of the language model. Although multiple language models may be combined, in one embodiment, the regional probabilities may not take the language model into account in order to prevent looping back language model information to the candidate list.

Data collected may be tied to the active keyboard layout. Layouts are identified by a combination of keyboard ID, page number and scaled size. For example, the keyboard ID may correspond to a particular keyboard language, such as English, Spanish, Norwegian, etc. The page number may be equal to ‘0’ for the standard alphanumeric keyboard, ‘1’ for a symbols keyboard, ‘3’ for a numeric keyboard, and so on. The scaled size may correspond to the physical size of the keyboard, which may vary depending on the physical size of the touch device on which the keyboard is displayed, as well as whether the keyboard is in portrait or in landscape orientation. The system may gather bias data for different language keyboards (e.g. for bilingual users), for different types of keyboards (alphabetic, numeric, symbol, etc.) and/or for different scaled sizes of keyboards.

Events may be kept for multiple layouts. If there are more active layouts than there is room for then the one not used for the longest time may be replaced when needed. A layout simply keeps track of the last n events in the form of quality, coordinate and key-index. The key index may map the language model keyboard database to a default keyboard database (e.g., a default keyboard database that is provided by the manufacturer of a touch device, such as under the static model.) Quality may include “delete”, “auto accept” and “explicit accept” or other events noted herein. A person of ordinary skill in the art will appreciate that a difference in quality of feedback may result, depending on whether a word selection was based on automatic choice or an explicit selection by a user. For example, a relatively strong indicator of negative feedback occurs when the user taps a character, deletes the character, and enters a new character to replace the deleted character. This event type may be retained as high quality negative feedback. After a selection list build, the system may provide a list of characters with weights to be used as the language model for the next tap input. The weight currently used may be the total score for the candidate. Weights for the same character may be summed up.

The system may submit a selected string to be compared to the current input (taps) and track if those taps yielded success or failure in returning the expected string. To decrease the required computational effort, the system may not perform complex analysis of spell corrected words. Further, the system may use plain regional corrected words.

The database may be persisted between sessions so that modifications made to the keyboard landscape and during one session may continue to take effect in one or more subsequent sessions. A session may correspond to the duration of time that one or more language model software routines are invoked. For example, a session may correspond to the composition of one or more e-mail messages, one or more edits to a document in a word processing program, the time between start-up and shutdown of a computer or computer operating system, etc. In addition, the database may be persisted on a per-user basis so that each of multiple users may load customized keyboard landscapes corresponding to individual user preferences or tendencies, based in part on the user identification module noted above.

Events in the input bias model may be stored in a database that can track different keyboard landscapes based on different key layouts (e.g., portrait or landscape), languages (e.g., English or German), user preferences (e.g., right-handed, left-handed, or ambidextrous), speed (e.g., walking speed, running speed, or stationary, as determined by a GPS unit or other device such as an accelerometer, which can affect user input accuracy), or other factors. The system may also track different keyboard landscapes based on time of day (e.g., prefer more formal spellings and word choices during daytime (business) hours and less formal spellings and word choices during evening hours) or person (e.g., individual user may indicate preference for certain word choices or levels of formality). The database may be configured to retain certain user events and delete other user events. For example, the database may retain a number of more recent events while discarding older events (e.g., retain only the most recent 1000 events). As another example, the database may be configured to discard both the most recent events and the oldest events while retaining the events that remain. In addition, the database may be configured to assign different weights to certain types of events. For example, more recent event may be assigned a higher weight the older events.

An automated test may be run to model a user entering sloppy text (i.e., coordinates that are off center). Results from the test may be used to verify that changes to the language models do not result in increased error rates. FIG. 17 represents an example of a neutral map that may result after running an English language test with no language model feedback applied. As shown in FIG. 17, the system retains protected areas for each key, which are depicted as white rectangles surrounding each letter. In addition, each key includes some surrounding area, which in this example generally includes some of the virtual keyboard area that is below and to the right of each protected area. The automated test may count the number of correct characters in the exact input and calculate the amount of error and bias. For example, an automated test may determine that a static model lowers the absolute error rate by about 6% (from 95% to 89%). In some cases, the traditional model may reach a maximum error rate reduction of 95% with perfect taps because the keyboard used may not contain all characters used in the test data and thus cannot be part of the exact by tapping. With the input bias and language models, however, the system may achieve an error rate reduction approaching 100%.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times.

The teachings of the invention provided herein can be applied to other systems, not necessarily the system described above. The elements and acts of the various examples described above can be combined to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims

While certain aspects of the invention are presented below in certain claim forms, the applicant contemplates the various aspects of the invention in any number of claim forms. For example, while only one aspect of the invention is recited as a means-plus-function claim under 35 U.S.C. sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

I/We claim:

1. A method for adjusting the operation of a virtual keyboard, comprising:
detecting a first input and a second input by the user on a virtual keyboard,
wherein the first and second inputs each include a set of coordinates corresponding to a touch of a user on the virtual keyboard, and
wherein each key on the virtual keyboard is defined by coordinates outlining an area on the keyboard for that key;
determining, in a language model, a predicted next key based on at least the first and second inputs; and
redefining the defined area on the virtual keyboard for the predicted next key,
wherein the redefining alters a probability of associating a third input by the user to the predicted next key, and
wherein altering the probability includes altering the defined area on the virtual keyboard corresponding to the predicted next key.

2. The method of claim 1, further comprising increasing a displayed size of the predicted next key on the virtual keyboard relative to one or more neighboring keys on the virtual keyboard display, and
wherein altering the probability includes increasing the defined area on the virtual keyboard corresponding to the predicted next key.

3. The method of claim 1, further comprising:
detecting a third input by the user on the virtual keyboard, wherein the third input includes a set of coordinates corresponding to a touch of a user on the virtual keyboard;
determining a selected key by identifying the key that corresponds to the coordinates indicated by the touch of the user on the virtual keyboard;
if the selected key matches the predicted next key:
retrieving a first weighting factor; and
increasing in the language model a weighting of the predicted next key for the detected first and second inputs; and
if the selected key does not match the predicted next key:
retrieving a second weighting factor; and
decreasing in the language model a weighting of the predicted next key for the detected first and second inputs.

4. The method of claim 1, wherein each key on the virtual keyboard is further defined by center coordinates for a probability distribution, and wherein redefining the defined area on the virtual keyboard for the predicted next key includes moving the center coordinates to a new location with respect to the virtual keyboard.

5. The method of claim 1, wherein detecting the first input or the second input includes determining probabilities of an intended input key based on an input bias model.

6. The method of claim 1, wherein detecting the first input or the second input includes using a static probability model for each key of the virtual keyboard, wherein each key is represented by coordinates outlining an area on the virtual keyboard that extends radially outward from center coordinates of that key.

7. The method of claim 1, further comprising:
detecting a keyboard type for the virtual keyboard, wherein the keyboard type corresponds to a language of the keys of the virtual keyboard, an alphabetic keyboard, a numeric keyboard, a portrait orientation of the virtual keyboard, or a landscape orientation of the virtual keyboard; and
selecting the language model based on the detected keyboard type.

8. At least one tangible computer-readable medium storing instructions, which when executed by at least one processor, adjusts operation of a virtual keyboard, comprising:
detecting a first input and a second input by the user on a virtual keyboard,
wherein the first and second inputs each include a set of coordinates indicated by a touch of a user on the virtual keyboard, and
wherein each key on the virtual keyboard is defined by coordinates defining an area on the keyboard for that key;
determining, in a language model, a predicted next key based on at least the first and second inputs; and
modifying the defined area on the virtual keyboard for the predicted next key,
wherein the modifying adjusts a probability of associating a third input by the user to the predicted next key, and
wherein adjusting the probability includes adjusting the defined area on the virtual keyboard corresponding to the predicted next key.

9. The at least one tangible computer-readable medium of claim 8, further comprising increasing a displayed size of the predicted next key on the virtual keyboard relative to one or more neighboring keys on the virtual keyboard display, and
wherein adjusting the probability includes increasing the defined area on the virtual keyboard corresponding to the predicted next key.

10. The at least one tangible computer-readable medium of claim 8, further comprising:
detecting a third input by the user on the virtual keyboard, wherein the third input includes a set of coordinates indicated by a touch of a user on the virtual keyboard;
determining a selected key by identifying the key that corresponds to the coordinates indicated by the touch of the user on the virtual keyboard;
if the selected key matches the predicted next key:
retrieving a first weighting factor; and
increasing in the language model a weighting of the predicted next key for the detected first and second inputs; and
if the selected key does not match the predicted next key:
retrieving a second weighting factor; and
decreasing in the language model a weighting of the predicted next key for the detected first and second inputs.

11. The at least one tangible computer-readable medium of claim 8, wherein each key on the virtual keyboard is further defined by center coordinates for a probability distribution, and wherein modifying the defined area on the virtual keyboard for the predicted next key includes moving the center coordinates to a new location with respect to the virtual keyboard.

12. The at least one tangible computer-readable medium of claim 8, wherein detecting the first input or the second input includes determining probabilities of an intended input key based on an input bias model.

13. The at least one tangible computer-readable medium of claim 8, wherein detecting the first input or the second input includes employing a static probability model for each key of the virtual keyboard, wherein each key is represented by coordinates defining an area on the virtual keyboard that extends radially outward from center coordinates of that key.

14. The at least one tangible computer-readable medium of claim 8, further comprising:
detecting a keyboard type for the virtual keyboard, wherein the keyboard type corresponds to a language of the keys of the virtual keyboard, an alphabetic keyboard, a numeric keyboard, a portrait orientation of the virtual keyboard, or a landscape orientation of the virtual keyboard; and
selecting the language model based on the detected keyboard type.

15. A system for adjusting the operation of a virtual keyboard, the system comprising:
at least one processor;
at least one data storage device storing instructions performed by the processor;
a keyboard coupled to the processor;
a first set of instructions for detecting a first input and a second input by the user on a virtual keyboard,
wherein the first and second inputs each include a set of coordinates indicated by a tap of a user on the virtual keyboard, and
wherein each key on the virtual keyboard is defined by coordinates forming an area on the keyboard for that key;
means for determining, in a language model, a predicted next key based on at least the first and second inputs; and
means for updating the defined area on the virtual keyboard for the predicted next key,
wherein the updating changes a probability of associating a third input by the user to the predicted next key, and
wherein changing the probability includes changing the defined area on the virtual keyboard corresponding to the predicted next key.

16. The system of claim 15, further comprising enlarging a displayed size of the predicted next key on the virtual keyboard relative to one or more neighboring keys on the virtual keyboard display, and
wherein changing the probability includes enlarging the defined area on the virtual keyboard corresponding to the predicted next key.

17. The system of claim 15, further comprising:
detecting a third input by the user on the virtual keyboard, wherein the third input includes a set of coordinates indicated by a tap of a user on the virtual keyboard;
determining a selected key by identifying the key that corresponds to the coordinates indicated by the tap of the user on the virtual keyboard;
if the selected key matches the predicted next key:
retrieving a first weighting factor; and
increasing in the language model a weighting of the predicted next key for the detected first and second inputs; and
if the selected key does not match the predicted next key:
retrieving a second weighting factor; and
decreasing in the language model a weighting of the predicted next key for the detected first and second inputs.

18. The system of claim 15, wherein each key on the virtual keyboard is further defined by center coordinates for a probability distribution, and wherein modifying the defined area on the virtual keyboard for the predicted next key includes relocating the center coordinates to a new location with respect to the virtual keyboard.

19. The system of claim 15, wherein detecting the first input or the second input includes employing a static probability model for each key of the virtual keyboard, wherein each key is represented by coordinates defining an area on the virtual keyboard that extends radially outward from center coordinates of that key.

20. The system of claim 15, further comprising:
detecting a keyboard category for the virtual keyboard, wherein the keyboard category corresponds to a language of the keys of the virtual keyboard, an alphabetic keyboard, a numeric keyboard, a portrait orientation of the virtual keyboard, or a landscape orientation of the virtual keyboard; and
selecting the language model based on the detected keyboard category.
